(19) United States
(12) Patent Application Publication
(10) Pub. No.: US 2020/0099041 A1
(43) Pub. Date: Mar. 26, 2020

(54) NEGATIVE ELECTRODE FOR LITHIUM ION SECONDARY BATTERY, LITHIUM ION SECONDARY BATTERY AND BATTERY PACK

(71) Applicant: Honda Motor Co.,Ltd., Tokyo (JP)

(72) Inventor: Tadashi MATSUSHITA, Saitama (JP)

(73) Assignee: Honda Motor Co.,Ltd., Tokyo (JP)

(21) Appl. No.: 16/575,392

(22) Filed: Sep. 19, 2019

(30) Foreign Application Priority Data
Sep. 25, 2018 (JP) 2018-178946

(51) Int. Cl. H01M 4/133; H01M 10/0525; C25B 11/12

(52) U.S. Cl. CPC H01M 4/133; H01M 2004/027; C25B 11/12; H01M 10/0525

(57) ABSTRACT

A negative electrode for a lithium ion secondary battery that can realize a lithium ion secondary battery that has both a high capacity and long cycle durability and a lithium ion secondary battery using the negative electrode for a lithium ion secondary battery are provided. A negative-electrode active material layer composes a negative electrode for a lithium ion secondary battery formed as a laminate in which a layer including crystalline carbon and a layer including amorphous carbon are laminated in a specific deposition. Specifically, the negative-electrode active material layer configured by the laminate including a lower layer adjacent to a current collector and an upper layer disposed on the side of the lower layer opposite to the current collector is set and the negative electrode for a lithium ion secondary battery in which the lower layer includes crystalline carbon particles and the upper layer includes amorphous carbon particles is set.

### CROSS-REFERENCE TO RELATED APPLICATION

This application claims the priority benefit of Japan Application No. 2018-178946, filed on Sep. 25, 2018. The entirety of the above-mentioned patent application is hereby incorporated by reference herein and made a part of this specification.

### BACKGROUND

### Technical Field

The present disclosure relates to a negative electrode for a lithium ion secondary battery and a lithium ion secondary battery using the negative electrode for a lithium ion secondary battery.

### Description of Related Art

Lithium ion secondary batteries functioning as secondary batteries having high energy density have become widespread since the past. Lithium ion secondary batteries using a liquid as an electrolyte have a structure in which a separator is interposed between a positive electrode and a negative electrode and that is filled with a liquid electrolyte (electrolytic solution).

Since an electrolytic solution of a lithium ion secondary battery is normally a combustible organic solvent, safety against heat is particularly important. Thus, a solid battery using a fire-resistant solid electrolyte has also been proposed (refer to Patent Document 1) in place of an organic liquid electrolyte.

Solid secondary batteries have an inorganic solid electrolyte, an organic solid electrolyte, or a gel-like solid electrolyte between a positive electrode and a negative electrode as an electrolyte layer. Solid batteries using solid electrolytes can solve the problem caused by heat, can have high capacities and/or high voltages, and can even meet the demands for a compact size in comparison to batteries using electrolytic solutions.

There still are various requirements to promote further application of such lithium ion secondary batteries. One is, for example, compatibility of a high capacity and long cycle durability.

Using graphite as a negative-electrode active material, for example, has been proposed to achieve a high capacity of a lithium ion secondary battery (refer to Patent Document 1). A lithium ion secondary battery using graphite as a negative-electrode active material has an advantage of increased charge and discharge capacities. However, since the battery has low lithium acceptance, long cycle durability tends to be degraded accordingly.

Meanwhile, using a high electric potential distribution active material such as hard carbon as a negative-electrode active material, for example, has been proposed for improving long cycle durability (refer to Patent Document 2). By using a high electric potential distribution active material such as hard carbon that has a stable structure at the time of charge and discharge of lithium ions as a negative-electrode active material, progress of a local battery reaction can be mitigated and cycle durability can be improved. However, lithium ion secondary batteries using hard carbon are inferior to lithium ion secondary batteries using graphite in terms of capacity.

Furthermore, a solid battery in which a composition obtained by mixing graphite and amorphous carbon is used as a negative-electrode active material has also been proposed (refer to Patent Document 3). By mixing graphite and amorphous carbon, a lithium ion secondary battery having excellent input/output characteristics and contact interface resistance can be obtained. However, the compatibility of high capacities with long cycle durability is unsatisfactory even with the mixture of graphite and amorphous carbon.

### PATENT DOCUMENTS

[Patent Document 1] Japanese Patent Laid-Open No. H10-226505

[Patent Document 2] Japanese Patent Laid-Open No. 2007-026724

[Patent Document 3] Japanese Patent Laid-Open No. 2012-146506

The present disclosure provides a negative electrode for a lithium ion secondary battery that can realize a lithium ion secondary battery that has both a high capacity and long cycle durability and a lithium ion secondary battery using the negative electrode for a lithium ion secondary battery.

The inventors intensively studied solutions to this problem. The inventors found the solution by forming a negative electrode of a negative-electrode active material layer for a lithium ion secondary battery, the layer configured by a laminate in which a layer including crystalline carbon and a layer including amorphous carbon are laminated in a specific deposition, and thereby completed the present disclosure.

### SUMMARY

That is, the present disclosure is a negative electrode for a lithium ion secondary battery having a current collector and a negative-electrode active material layer including a negative-electrode active material formed on at least one side of the current collector, in which the negative-electrode active material layer is a laminate including multiple layers, the laminate has a lower layer adjacent to the current collector and an upper layer disposed on the side of the lower layer opposite to the current collector, the lower layer includes crystalline carbon particles, and the upper layer includes amorphous carbon particles.

According to the embodiment, a thickness ratio of the upper layer and the lower layer may be 5:95 to 20:80.

According to the embodiment, an average particle size (D50) of the crystalline carbon particles may be 25 μm or less.

According to the embodiment, an average particle size (D50) of the amorphous carbon particles may be 25 μm or less.

According to the embodiment, the average particle size (D50) of the amorphous carbon particles may be 18 μm or less, and the average particle size (D50) of the crystalline carbon particles may be greater than the average particle size (D50) of the amorphous carbon particles.

According to the embodiment, a basis weight of the negative-electrode active material layer formed on one side of the current collector may be 8 mg/cm² or more.

In addition, another embodiment of the present disclosure is a lithium ion secondary battery including the above-described negative electrode for a lithium ion secondary battery, a positive electrode, and an electrolyte.

In addition, another embodiment of the present disclosure is a battery pack including the above-described lithium ion secondary battery, a control part controlling the lithium ion secondary battery, and an exterior containing the lithium ion secondary battery.

### DESCRIPTION OF THE EMBODIMENTS

According to the negative electrode for a lithium ion secondary battery of the present disclosure, a lithium ion secondary battery that has both a high capacity and long cycle durability can be realized.

The present disclosure will be described below. However, the following description is merely an example and does not limit the present disclosure.

<Negative Electrode for Lithium Ion Secondary Battery>

A negative electrode for a lithium ion secondary battery of the present disclosure is a negative electrode for a lithium ion secondary battery having a current collector and a negative-electrode active material layer including a negative-electrode active material formed on at least one side of the current collector, and the negative-electrode active material layer is a laminate including multiple layers. The laminate serving as the negative-electrode active material layer has a lower layer adjacent to the current collector and an upper layer disposed on the side of the lower layer opposite to the current collector. In addition, the lower layer of the negative-electrode active material layer includes crystalline carbon particles and the upper layer includes amorphous carbon particles.

Batteries to which the negative electrode for a lithium ion secondary battery of the present disclosure is applied are not particularly limited. They may be liquid lithium ion secondary batteries having an electrolyte solution or solid batteries having a solid or gel electrolyte. In addition, when the negative electrode for a lithium ion secondary battery of the present disclosure is applied to a battery having a solid or gel electrolyte, the electrolyte may be organic or inorganic.

[Current Collector]

A current collector that constitutes the negative electrode for a lithium ion secondary battery of the present disclosure is not particularly limited, and a known current collector used in a lithium ion secondary battery can be used. Examples of a negative-electrode current collector include, for example, copper foil, stainless steel (SUS) foil, nickel foil, carbon foil, and the like. Although an example of the thickness is, for example, 1 to 20 μm, the thickness is not limited thereto.

[Negative-Electrode Active Material Layer]

(Laminate)

The negative-electrode active material layer that constitutes the negative electrode for a lithium ion secondary battery of the present disclosure has a laminate structure including multiple layers. In the present disclosure, the laminate forming the negative-electrode active material layer has a lower layer adjacent to the current collector and an upper layer disposed on the side of the lower layer opposite to the current collector.

In addition, the negative-electrode active material layer may be formed on at least one side or both sides of the current collector in the negative electrode for a lithium ion secondary battery of the present disclosure. In addition, the negative-electrode active material layer on one side may have a laminate structure including multiple layers of the present disclosure, and the negative-electrode active material layer on the other side may be a negative-electrode active material layer having a different structure. Further, in the present disclosure, it is preferable to form the negative-electrode active material layer on both sides of the current collector.

Further, in the negative electrode for a lithium ion secondary battery of the present disclosure, the negative-electrode active material layer having the laminate structure may include at least the above-described upper layer and lower layer or may arbitrarily include another layer. The arrangement of other layers is not particularly limited, and maybe appropriately disposed at a necessary position, for example, between the upper layer and the lower layer, further upward than the upper layer, or the like.

In addition, in the negative electrode for a lithium ion secondary battery of the present disclosure, the negative-electrode active material layer may be formed on at least one side or both sides of the current collector. A formation position can be appropriately selected depending on the type or structure of the target lithium ion secondary battery.

(Thickness of Negative-Electrode Active Material Layer)

A thickness of the entire negative-electrode active material layer is not particularly limited, and can be appropriately designed according to required performance of the lithium ion secondary battery. The thickness is preferably, for example, in a range of 20 μm to 1000 μm.

(Basis Weight of Negative-Electrode Active Material Layer)

In the negative electrode for a lithium ion secondary battery of the present disclosure, a basis weight of the negative-electrode active material layer having the above-described laminate structure is preferably 8 mg/cm² or more in terms of conversion for a single side. The negative-electrode active material layer according to the present disclosure has a laminate structure at least including the upper layer and the lower layer and arbitrarily including another layer. Thus, a basis weight of the negative-electrode active material layer according to the present disclosure refers to a basis weight of the entire negative-electrode active material layer having the laminate structure at least including the upper layer and the lower layer and arbitrarily including another layer on one side of the current collector.

In a lithium ion secondary battery, no deterioration caused by electrodeposition normally occurs when a negative-electrode active material layer is a thin film. However, if a basis weight of the negative-electrode active material layer formed on the current collector is 8 mg/cm² or more in terms of conversion for a single side, electrodeposition easily occurs, which leads to deterioration of long cycle durability.

Since the negative electrode for a lithium ion secondary battery of the present disclosure has the effect of suppressing electrodeposition, even if a basis weight of the negative-electrode active material layer formed on the current collector is set to 8 mg/cm² or more for one side, long cycle durability can be achieved. Further, even if a basis weight of the negative-electrode active material layer formed on the current collector is less than 8 mg/cm² in terms of conversion for a single side in the present disclosure, the effect can be sufficiently exhibited.

[Lower Layer]

The lower layer of the negative-electrode active material layer is adjacent to the current collector. The lower layer of the negative-electrode active material layer includes crystalline carbon particles as the negative-electrode active material. Since the lower layer includes crystalline carbon particles, the negative electrode for a lithium ion secondary battery of the present disclosure can realize a lithium ion secondary battery with a high capacity.

(Crystalline Carbon Particles)

Although crystalline carbon is not particularly limited, examples of the crystalline carbon include, for example, fibrous carbon such as carbon nanotubes, highly oriented pyrolytic graphite or HOPG, and graphite including natural graphite or artificial graphite. Among these, graphite including natural graphite or artificial graphite that makes insertion and desorption of lithium ions easier is preferred.

(Average Particle Size of Crystalline Carbon Particles)

An average particle size (D50) of crystalline carbon particles is preferably 25 μm or less. An average particle size of 20 μm or less is more preferable, and an average particle size of 18 μm or less is particularly preferable.

Since graphite serving as a negative-electrode active material in the lithium ion secondary battery generally has improved crystallinity as the particle size is greater, while a capacity per unit weight increases, ion diffusion inside solids is reduced, and as a result, the output of the battery itself decreases. If an average particle size (D50) of the crystalline carbon particles is 25 μm or less, reduced output of the formed lithium ion secondary battery can be prevented.

In addition, an average particle size (D50) of crystalline carbon particles included in the lower layer is preferably greater than an average particle size (D50) of amorphous carbon particles included in the upper layer. If the average particle size (D50) of the crystalline carbon particles is greater than the average particle size (D50) of the amorphous carbon particles, coating of the upper layer and the lower layer forming the negative-electrode active material layer becomes easy and ion transport at the time of insertion and desorption of lithium ions becomes smoother.

(Other Components)

The lower layer of the negative-electrode active material layer may arbitrarily include another known component that can be blended with a negative-electrode active material of a solid electrolyte in addition to crystalline carbon particles. Examples of the other component include, for example, a conduction auxiliary agent, a binder, a solid electrolyte, and the like.

A content of the crystalline carbon particles in the lower layer is not particularly limited, and can be appropriately determined depending on the type or structure of the formed lithium ion secondary battery.

(Thickness of Lower Layer)

A thickness of the lower layer of the negative-electrode active material layer can be appropriately designed by adjusting it with respect to another negative-electrode active material layer such as the upper layer according to required performance of the lithium ion secondary battery. The thickness of the lower layer after electrode press is preferably, for example, in a range of 40 μm to 300 μm. When the thickness of the lower layer after electrode press is thinner than 40 μm, it may be difficult to secure a sufficient basis weight, and on the other hand, when the thickness exceeds 300 μm, output performance of the formed lithium ion secondary battery may not be guaranteed.

[Upper Layer]

The upper layer of the negative-electrode active material layer is disposed on the side of the above-described lower layer opposite to the current collector. The upper layer of the negative-electrode active material layer includes amorphous carbon particles as a negative-electrode active material. By disposing a layer including amorphous carbon particles on the upper layer, Li acceptance can be improved. As a result, the negative electrode for a lithium ion secondary battery of the present disclosure can exhibit sufficient long cycle durability.

(Amorphous Carbon Particles)

Although amorphous carbon is not particularly limited, examples thereof include, for example, hard carbon, soft carbon (low-temperature calcined carbon), a mesophase pitch-based carbide, calcined coke, and the like. Among these, hard carbon is preferable since it has a relatively high active material capacity per unit weight, and excellent fast charge performance and charge/discharge cycle performance.

(Average Particle Size of Amorphous Carbon Particles)

An average particle size (D50) of amorphous carbon particles is preferably 25 μm or less. The average particle size is more preferably 23 μm or less, even more preferably 18 μm or less, even more preferably 15 μm or less, and particularly preferably 10 μm or less.

Since graphite serving as a negative-electrode active material in the lithium ion secondary battery generally has improved crystallinity as the particle size is greater, while a capacity per unit weight increases, ion diffusion inside solids is reduced, and as a result, the output of the battery itself decreases. If an average particle size (D50) of the amorphous carbon particles is 25 μm or less, reduced output of the formed lithium ion secondary battery can be prevented.

Particularly in the present disclosure, it is preferable for an average particle size (D50) of the amorphous carbon particles to be 18 μm or less and for an average particle size (D50) of the crystalline carbon particles included in the lower layer to be greater than an average particle size (D50) of the amorphous carbon particles included in the upper layer. Accordingly, reduced output of the formed lithium ion secondary battery can be particularly prevented.

(Other Components)

The upper layer of the negative-electrode active material layer may arbitrarily include another known component that can be blended with a negative-electrode active material of a solid electrolyte in addition to amorphous carbon particles. Examples of the other component include, for example, a conduction auxiliary agent, a binder, a solid electrolyte, and the like.

A content of the amorphous carbon particles in the upper layer is not particularly limited, and can be appropriately determined depending on the type or structure of the formed lithium ion secondary battery.

(Thickness of Upper Layer)

A thickness of the upper layer of the negative-electrode active material layer can be appropriately designed by adjusting it with respect to another negative-electrode active material layer such as the lower layer according to required performance of the lithium ion secondary battery. The thickness of the upper layer after electrode press is preferably, for example, in a range of 5 μm to 150 μm. When the thickness of the upper layer after electrode press is thinner than 5 μm, formation through coating is practically difficult, and on the other hand, when the thickness exceeds 150 μm, output performance of the formed lithium ion secondary battery may not be guaranteed.

[Thickness Ratio of Upper Layer and Lower Layer]

A thickness ratio of the upper layer and the lower layer is preferably in a range of 5:95 to 20:80. The thickness ratio is more preferably in a range of 10:90 to 20:80, and particularly preferably in a range of 15:85 to 20:80.

If a thickness ratio of the upper layer and the lower layer is in a range of 5:95 to 20:80, balance between Li acceptance by the upper layer including the amorphous carbon particles and a secured capacity of the lower layer including the crystalline carbon particles can be attained, and as a result, a lithium ion secondary battery that has both a high capacity and long cycle durability can be realized by the negative electrode for a lithium ion secondary battery of the present disclosure.

<Method for Manufacturing Negative Electrode for Lithium Ion Secondary Battery>

A method for manufacturing the negative electrode for a lithium ion secondary battery is not particularly limited, and a known method for manufacturing a negative electrode for a lithium ion secondary battery can be applied.

<Lithium Ion Secondary Battery>

A lithium ion secondary battery of the present disclosure has a negative electrode for a lithium ion secondary battery of the present disclosure, a positive electrode, and an electrolyte.

[Positive Electrode]

A positive electrode to be applied to the lithium ion secondary battery of the present disclosure is not particularly limited and any material that functions as a positive electrode of a lithium ion secondary battery is applicable.

For example, a material showing sufficiently high potential in comparison to the negative electrode for a lithium ion secondary battery of the present disclosure can be selected as a material among materials that can compose an electrode and constitute an arbitrary battery.

[Electrolyte]

The electrolyte constituting the lithium ion secondary battery of the present disclosure may be a liquid-type electrolytic solution, or a solid or gel electrolyte. An electrolyte that can constitute the lithium ion secondary battery is applicable without any particular problem.

<Method for Manufacturing Lithium Ion Secondary Battery>

A method for manufacturing a lithium ion secondary battery of the present disclosure is not particularly limited and a known method for manufacturing a lithium ion secondary battery can be applied.

### Example 1

Examples and the like of the present disclosure will be described next, however, the present disclosure is not limited thereto.

### Reference Examples 1 and 2

[Production of Negative Electrode for Lithium Ion Secondary Battery]

As a negative-electrode active material, 97 parts by mass graphite (having an average particle size D50=18 μm), 1 part by mass acetylene black as a conduction auxiliary agent, 1 part by mass carboxymethylcellulose (CMC) sodium, and 1 part by mass styrene butadiene rubber (SBR) as a binder were mixed together, the obtained mixture was dispersed in an appropriate amount of ion exchange water, and thereby a slurry was produced. Copper foil having a thickness of 12 μm was prepared as a current collector, the produced slurry was applied on both sides of the current collector and dried at 100° C. for 10 minutes, the current collector was pressed to have a predetermined thickness, and thereby a negative electrode for a lithium ion secondary battery in which single negative-electrode active material layers were formed on both sides of the current collector was produced. Further, in reference examples 1 and 2, electrodes having negative-electrode active material layers with different thicknesses were produced by changing an application amount of the slurry.

[Evaluation of Negative-Electrode Active Material Layer]

(Basis Weight of Negative-Electrode Active Material Layer)

Each of the obtained negative electrodes for a lithium ion secondary battery was punched using a Φ20 punching machine, the weight of the current collector was deducted therefrom, thereby the weight of the negative-electrode active material layer was obtained, and then the basis weight thereof per unit area was obtained using the following formula. Further, when the negative-electrode active material layer was formed on both sides, the value of the basis weight per unit area was halved, and thereby the basis weight could be obtained in terms of single side conversion. The basis weights in terms of conversion for a single side are shown in Table 1.

Basis weight (mg/cm²)=(weight of electrode−weight of current collector)÷area of electrode

[Production of Lithium Ion Secondary Battery]

(Production of Positive Electrode)

94 parts by mass LiNi_{0.5}Co_{0.2}Mn_{0.3}O₂ as a positive-electrode active material, 3 parts by mass acetylene black as a conduction auxiliary agent, and 3 parts by mass vinylidene fluoride as a binder were mixed, the obtained mixture was dispersed in an appropriate amount of N-methyl-2-pyrrolidone, and thereby a slurry was produced. Aluminum foil having a thickness of 12 μm was prepared as a current collector, the produced slurry was applied onto both sides of the current collector and dried at 100° C. for 10 minutes to form positive-electrode active material layers on both sides of the current collector, the current collector was then pressed to a predetermined thickness, and thereby a positive electrode for a lithium ion secondary battery was manufactured.

(Production of Lithium Ion Secondary Battery)

A battery was produced using the above-described obtained negative electrode and positive electrode for a lithium ion secondary battery and a solution in which 1 mol of LiPF₆ was dissolved in a solvent which was obtained by mixing ethylene carbonate, dimethyl carbonate, ethyl methyl carbonate at a volume ratio of 3:4:3 as an electrolytic solution.

[Evaluation of Lithium Ion Secondary Battery]

(Initial Capacity)

A charge/discharge test was performed on the produced lithium ion secondary battery four times at a 0.1C rate with a lower limit voltage of 2.5 V and an upper limit voltage of 4.2 V, and the fourth discharge capacity was set as an initial capacity.

(50% Capacity Maintenance Cycle)

Tests of charge at a 1C rate and discharge at a 2C rate were performed on the produced lithium ion secondary battery with the lower limit voltage of 2.5 V and the upper limit voltage of 4.2 V at an environment temperature of 5° C., and the number of charge/discharge cycles until the initial capacity reached 50% was counted. The results are shown in Table 1.

(Initial Li Acceptance)

A half cell of a counter electrode Li was produced using the obtained negative electrode for a lithium ion secondary battery. A 3C-rate charge test was performed on the produced half cell, and the capacity when the voltage reached 0 V was obtained. For initial Li acceptance, a single hard carbon layer was formed as a negative-electrode active material layer so that a basis weight in terms of conversion for a single side was the same as in reference examples 1 and 2, and assuming that the capacity when the voltage reached 0 V when a charge test at a 3C rate was performed was 100%, the ratios of measured result capacities of the examples were obtained as percentages. The results are shown in Table 1.

TABLE 1

| | | | | | | Basis weight of | | | |
|---|---|---|---|---|---|---|---|---|---|
| | | | | | | negative-electrode | | | |
| | | | | | | active material | | | |
| | Upper layer | | Lower layer | | Thickness | layer in terms of | | | |
| | | Average | | Average | ratio (upper | conversion for | | 50% capacity | |
| | | particle size | | particle size | layer:lower | single side | Cell capacity | maintenance | Initial Li |
| | Material | (D50) (μm) | Material | (D50) (μm) | layer) | (mg/cm²) | (Wh/L) | cycle | acceptance |
| Example 1 | Hard carbon | 10 | Graphite | 18 | 5:95 | 10 | 99% | 670 | 80% |
| Example 2 | Hard carbon | 10 | Graphite | 18 | 10:90 | 10 | 98% | 720 | 85% |
| Example 3 | Hard carbon | 18 | Graphite | 25 | 10:90 | 10 | 98% | 670 | 77% |
| Example 4 | Hard carbon | 15 | Graphite | 20 | 10:90 | 10 | 98% | 690 | 80% |
| Example 5 | Hard carbon | 10 | Graphite | 18 | 15:85 | 10 | 97% | 750 | 85% |
| Example 6 | Hard carbon | 10 | Graphite | 18 | 20:80 | 10 | 95% | 750 | 90% |
| Example 7 | Hard carbon | 23 | Graphite | 25 | 10:90 | 10 | 98% | 500 | 60% |
| Example 8 | Hard carbon | 23 | Graphite | 30 | 10:90 | 10 | 98% | 460 | 52% |
| Example 9 | Hard carbon | 25 | Graphite | 18 | 10:90 | 10 | 98% | 580 | 65% |
| Example 10 | Hard carbon | 10 | Graphite | 18 | 30:70 | 10 | 90% | 750 | 90% |
| Example 11 | Hard carbon | 10 | Graphite | 18 | 50:50 | 10 | 86% | 770 | 95% |
| Comparative | Graphite | 18 | Hard carbon | 10 | 80:20 | 10 | 95% | 400 | 50% |
| example 1 | | | | | | | | | |

| Comparative | Graphite | 18 | — | 10 | 100% | 300 | 40% |
|---|---|---|---|---|---|---|---|
| example 2 | | | | | | | |
| Comparative | Hard carbon | 10 | — | 10 | 65% | 1000 | 100% |
| example 3 | | | | | | | |
| Comparative | Hard carbon + Graphite | | — | 10 | 95% | 450 | 60% |
| example 4 | (Hard carbon: D50 = 10, Graphite: D50 = 18 | | | | | | |
| Reference | Graphite | 18 | — | 4 | — | 800 | 90% |
| example 1 | | | | | | | |
| Reference | Graphite | 18 | — | 7 | — | 700 | 80% |
| example 2 | | | | | | | |

### Example 1

[Production of Negative Electrode for Lithium Ion Secondary Battery]

(Production of Lower Layer)

97 parts by mass graphite (average particle size D50=18 μm) as a negative-electrode active material, 1 part by mass acetylene black as a conduction auxiliary agent, 1 part by mass carboxymethylcellulose sodium (CMC) and 1 part by mass styrene butadiene rubber (SBR) as a binder were mixed, the obtained mixture was dispersed in an appropriate amount of ion exchange water, and thereby a slurry was produced. Copper foil having a thickness of 12 μm was prepared as a current collector, the produced slurry was applied onto both sides of the current collector and dried at 100° C. for 10 minutes, and thereby lower layers were formed on both sides of the current collector.

(Production of Upper Layer)

94 parts by mass hard carbon (average particle size D50=10 μm) as a negative-electrode active material, 3 parts by mass acetylene black as a conduction auxiliary agent, 3 parts by mass polyvinylidene fluoride (PVDF) as a binder were mixed, the obtained mixture was dispersed in an appropriate amount of N-methyl-pyrrolidone, and thereby a slurry was produced. The produced slurry was applied on the formed lower layers and dried at 100° C. for 10 minutes, thereby negative-electrode active material layers having upper layers laminated on the lower layers were formed on both sides of the current collector and pressed to have a predetermined thickness, and thereby a negative electrode for a lithium ion secondary battery was formed.

[Evaluation of Negative-Electrode Active Material Layer]

(Thickness Ratio of Upper Layer and Lower Layer)

A cross section of the obtained negative electrode for a lithium ion secondary battery was cut using a microtome, the cut cross section was observed using an SEM, and thereby a thickness ratio of the upper layer and the lower layer (upper layer:lower layer) was obtained. The result is shown in Table 1.

(Basis Weight of Negative-Electrode Active Material Layer)

The basis weight of the obtained negative-electrode active material layer of the negative electrode for a lithium ion secondary battery was obtained similarly to reference examples 1 and 2. The result is shown in Table 1.

[Evaluation of Lithium Ion Secondary Battery]

A lithium ion secondary battery was produced similarly to reference examples 1 and 2 using the obtained negative electrode for a lithium ion secondary battery and the battery was variously evaluated.

(Initial Capacity) A charge/discharge test was performed on the produced lithium ion secondary battery four times at a 0.1C rate with a lower limit voltage of 2.5 V and an upper limit voltage of 4.2 V, and the fourth discharge capacity was set as an initial capacity.

(Cell Capacity)

Assuming that an initial capacity of a lithium ion secondary battery obtained in comparative example 2 (an example in which a negative-electrode active material layer was set to a single hard carbon layer), which will be described below, was 100%, the obtained initial capacity expressed as a percentage value was set as a cell capacity. The result is shown in Table 1.

(50% Capacity Maintenance Cycle)

Tests of charge at a 1C rate and discharge at a 2C rate were performed on the produced lithium ion secondary battery with the lower limit voltage of 2.5 V and the upper limit voltage of 4.2 V at an environment temperature of 5° C., and the number of charge/discharge cycles until the obtained initial capacity reached 50% was counted. The result is shown in Table 1.

(Initial Li Acceptance)

A half cell of a counter electrode Li was produced using the obtained negative electrode for a lithium ion secondary battery, a charge test was performed thereon, and the capacity when the voltage reached 0 V was obtained. For initial Li acceptance, assuming that the capacity when the voltage reached 0 V when a charge test at a 3C rate was performed was 100%, the ratio of the measured result capacity of comparative example 3 (an example in which a negative-electrode active material layer was set as a single hard carbon layer), which will be described below, was obtained as a percentage. The results are shown in Table 1.

### Examples 2 to 11

[Production of Negative Electrode for Lithium Ion Secondary Battery]

A negative electrode for a lithium ion secondary battery was produced similarly to example 1 except that negative-electrode active material layers each including an upper layer and a lower layer were formed on both sides of a current collector using graphite blended in the lower layer of the negative-electrode active material layer and hard carbon blended in the upper layer having the particle sizes shown in Table 1 to have the thickness ratio shown in Table 1.

[Evaluation of Negative-Electrode Active Material Layer]

The obtained negative electrode for a lithium ion secondary battery was evaluated similarly to example 1. The result is shown in Table 1.

[Evaluation of Lithium Ion Secondary Battery]

A lithium ion secondary battery was produced using the obtained negative electrode for a lithium ion secondary battery similarly to reference examples 1 and 2, and the battery was variously evaluated similarly to example 1. The result is shown in Table 1.

### Comparative Example 1

[Production of Negative Electrode for Lithium Ion Secondary Battery]

A negative electrode for a lithium ion secondary battery was produced by forming negative-electrode active material layers each including an upper layer and a lower layer on both sides of a current collector by using hard carbon having the particle size shown in Table 1 blended in the lower layer of the negative-electrode active material layer and graphite having the particle size shown in Table 1 blended in the upper layer to have the thickness ratio shown in Table 1.

[Evaluation of Negative-Electrode Active Material Layer]

The obtained negative electrode for a lithium ion secondary battery was evaluated similarly to example 1. The result is shown in Table 1.

[Evaluation of Lithium Ion Secondary Battery]

A lithium ion secondary battery was produced using the obtained negative electrode for a lithium ion secondary battery similarly to reference examples 1 and 2, and the battery was variously evaluated similarly to example 1. The result is shown in Table 1.

### Comparative Example 2

[Production of Negative Electrode for Lithium Ion Secondary Battery]

A negative electrode for a lithium ion secondary battery was produced by forming single negative-electrode active material layers on both sides of a current collector by using graphite having the particle size shown in Table 1 as a negative-electrode active material layer similarly to reference examples 1 and 2.

[Evaluation of Negative-Electrode Active Material Layer]

A basis weight of the negative-electrode active material layer of the obtained negative electrode for a lithium ion secondary battery in terms of conversion for a single side is shown in Table 1.

[Evaluation of Lithium Ion Secondary Battery]

A lithium ion secondary battery was produced using the obtained negative electrode for a lithium ion secondary battery similarly to reference examples 1 and 2, and the battery was variously evaluated similarly to example 1. The result is shown in Table 1.

### Comparative Example 3

[Production of Negative Electrode for Lithium Ion Secondary Battery]

A negative electrode for a lithium ion secondary battery was produced by forming single negative-electrode active material layers on both sides of a current collector by using hard carbon having the particle size shown in Table 1 as a negative-electrode active material layer similarly to the method for forming the upper layer of example 1.

[Evaluation of Negative-Electrode Active Material Layer]

A basis weight of the negative-electrode active material layer of the obtained negative electrode for a lithium ion secondary battery in terms of conversion for a single side is shown in Table 1.

[Evaluation of Lithium Ion Secondary Battery]

A lithium ion secondary battery was produced using the obtained negative electrode for a lithium ion secondary battery similarly to reference examples 1 and 2, and the battery was variously evaluated similarly to example 1. The result is shown in Table 1.

### Comparative Example 4

[Production of Negative Electrode for Lithium Ion Secondary Battery]

A negative electrode for a lithium ion secondary battery was produced by forming single negative-electrode active material layers on both sides of a current collector as a negative-electrode active material layer by blending hard carbon and graphite having the particle size shown in Table 1 in an amount in which a thickness ratio of an upper layer and a lower layer was 20:80 (the amount used for forming the negative-electrode active material layer of example 6).

[Evaluation of Negative-Electrode Active Material Layer]

A basis weight of the negative-electrode active material layer of the obtained negative electrode for a lithium ion secondary battery in terms of conversion for a single side is shown in Table 1.

[Evaluation of Lithium Ion Secondary Battery]

A lithium ion secondary battery was produced using the obtained negative electrode for a lithium ion secondary battery similarly to reference examples 1 and 2, and the battery was variously evaluated similarly to example 1. The result is shown in Table 1.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A negative electrode for a lithium ion secondary battery comprising:
a current collector; and
a negative-electrode active material layer comprising a negative-electrode active material formed on at least one side of the current collector,
wherein the negative-electrode active material layer is a laminate comprising multiple layers,
wherein the laminate has a lower layer adjacent to the current collector and an upper layer disposed on the side of the lower layer opposite to the current collector,
wherein the lower layer comprises crystalline carbon particles, and
wherein the upper layer comprises amorphous carbon particles.

2. The negative electrode for a lithium ion secondary battery according to claim 1, wherein a thickness ratio of the upper layer and the lower layer is 5:95 to 20:80.

3. The negative electrode for a lithium ion secondary battery according to claim 1, wherein an average particle size (D50) of the crystalline carbon particles is 25 μm or less.

4. The negative electrode for a lithium ion secondary battery according to claim 1, wherein an average particle size (D50) of the amorphous carbon particles is 25 μm or less.

5. The negative electrode for a lithium ion secondary battery according to claim 1, wherein the average particle size (D50) of the amorphous carbon particles is 18 μm or less, and
an average particle size (D50) of the crystalline carbon particles is greater than an average particle size (D50) of the amorphous carbon particles.

6. The negative electrode for a lithium ion secondary battery according to claim 1, wherein a basis weight of the negative-electrode active material layer formed on one side of the current collector is 8 mg/cm² or more.

7. A lithium ion secondary battery comprising:
the negative electrode for a lithium ion secondary battery according to claim 1;
a positive electrode; and
an electrolyte.

8. A battery pack comprising:
the lithium ion secondary battery according to claim 7;
a control part controlling the lithium ion secondary battery; and
an exterior containing the lithium ion secondary battery.

9. The negative electrode for a lithium ion secondary battery according to claim 2, wherein an average particle size (D50) of the crystalline carbon particles is 25 μm or less.

10. The negative electrode for a lithium ion secondary battery according to claim 2, wherein an average particle size (D50) of the amorphous carbon particles is 25 μm or less.

11. The negative electrode for a lithium ion secondary battery according to claim 3, wherein an average particle size (D50) of the amorphous carbon particles is 25 μm or less.

12. The negative electrode for a lithium ion secondary battery according to claim 2, wherein the average particle size (D50) of the amorphous carbon particles is 18 μm or less, and
an average particle size (D50) of the crystalline carbon particles is greater than an average particle size (D50) of the amorphous carbon particles.

13. The negative electrode for a lithium ion secondary battery according to claim 3, wherein the average particle size (D50) of the amorphous carbon particles is 18 μm or less, and
an average particle size (D50) of the crystalline carbon particles is greater than an average particle size (D50) of the amorphous carbon particles.

14. The negative electrode for a lithium ion secondary battery according to claim 4, wherein the average particle size (D50) of the amorphous carbon particles is 18 μm or less, and
an average particle size (D50) of the crystalline carbon particles is greater than an average particle size (D50) of the amorphous carbon particles.

15. The negative electrode for a lithium ion secondary battery according to claim 2, wherein a basis weight of the negative-electrode active material layer formed on one side of the current collector is 8 mg/cm² or more.

16. The negative electrode for a lithium ion secondary battery according to claim 3, wherein a basis weight of the negative-electrode active material layer formed on one side of the current collector is 8 mg/cm² or more.

17. The negative electrode for a lithium ion secondary battery according to claim 4, wherein a basis weight of the negative-electrode active material layer formed on one side of the current collector is 8 mg/cm² or more.

18. The negative electrode for a lithium ion secondary battery according to claim 5, wherein a basis weight of the negative-electrode active material layer formed on one side of the current collector is 8 mg/cm² or more.

19. A lithium ion secondary battery comprising:
the negative electrode for a lithium ion secondary battery according to claim 2;
a positive electrode; and
an electrolyte.

20. A lithium ion secondary battery comprising:
the negative electrode for a lithium ion secondary battery according to claim 3;
a positive electrode; and
an electrolyte.
